(19) United States
(12) Patent Application Publication
(10) Pub. No.: US 2008/0224523 A1
(43) Pub. Date: Sep. 18, 2008

(54) Seat with Easy-Entry and Cargo Function

(76) Inventors: Dave Watkins, Stockport (GB); Hans Schmodde, Dagersheim (DE); Robert Schule, Dagersheim (DE)

Correspondence Address: FOLEY AND LARDNER LLP;SUITE 500, 3000 K STREET NW, WASHINGTON, DC, 20007, US

(21) Appl. No.: 10/564,870

(22) PCT Filed: Jul. 1, 2004
(86) PCT No.: PCT/EP2004/007159

§ 371 Date: Apr. 12, 2007

(30) Foreign Application Priority Data
Jul. 17, 2003 (DE) 103 32 762.2

(51) Int. Cl. B60N 2/20

(52) U.S. Cl. 297/378.1

(57) ABSTRACT

A vehicle seat has a seat lower component, a seat upholstered component and a backrest component provided to be rotatably moved about a first axis provided parallel to a direction aligned transverse to the primary sitting direction. The vehicle seat upholstered component is also rotatably movable relative to the seat lower component about a second axis, the second axis being provided parallel to a direction from an upholstered component use position into an upholstered component loading position and vice versa, and the backrest component is provided to be rotatably moved relative to the seat lower component about the first axis from a backrest use position into a backrest loading position, and vice versa, only when the seat upholstered component has been moved substantially into the upholstered component loading position. By folding over the seat upholstered component into its upholstered component loading position, the backrest component can move relative to the seat lower component into its loading position, i.e. the backrest loading position.

### CROSS-REFERENCE TO RELATED APPLICATIONS

German Priority Application DE 10332762.2, filed Jul. 17, 2003, including the specification, drawings, claims and abstract, is incorporated herein by reference in its entirety. This application is a U.S. National Stage Application of PCT/EP2004/007159, filed Jul. 1, 2004, incorporated herein by reference in its entirety.

### BACKGROUND

The present invention relates generally to the field of automobile manufacturing and, in particular, vehicle seats. More particularly, the invention relates to a vehicle seat. For multi-purpose motor vehicles in particular, it is necessary for seats to be adaptable, particularly as regards their spatial arrangement, to those multiple purposes.

Patent Specification U.S. Pat. No. 6,000,742, for example, discloses a vehicle seat in the case of which three positions of the seat are provided. First, a use position of the seat is provided, then a loading position is provided in which the seat frees as much loading space as possible and, furthermore, a fold-down position is provided, permitting easy access to a vehicle area located behind the vehicle seat. In this case, it is a disadvantage that a complex mechanism for folding away the seat is provided, and that the complex mechanism is also situated fully in the force path taken up in the event of an accident with the vehicle. It is therefore necessary to design the complex folding mechanism in a very stable and durable way. This results in the disadvantage that the known vehicle seat becomes expensive and heavy, which is a further obstacle to its use in modern motor vehicles.

### SUMMARY

According to one embodiment of the invention, a seat, in particular a vehicle seat, has a seat lower component, a seat upholstered component and a backrest component, the backrest component being provided so that it can be rotatably moved about a first axis, the first axis being provided parallel to a direction that is aligned transverse to the primary sitting direction. The seat upholstered component is provided to be rotatably moved relative to the seat lower component about a second axis, the second axis being provided parallel to a direction that is aligned transverse to the direction of movement of the upholstered component from an upholstered component use position into an upholstered component loading position and vice versa. The backrest component is provided to be rotatably moved relative to the seat lower component about the first axis from a backrest use position into a backrest loading position and vice versa only when the seat upholstered component has been moved substantially into the upholstered component loading position. By folding over the seat upholstered component into its upholstered component loading position, the backrest component can move relative to the seat lower component likewise into its loading position, i.e. the backrest loading position. Changing the seat from its use position to its loading position—i.e. changing both the backrest component from its backrest use position to its backrest loading position and also the seat upholstered component from its upholstered component use position to its upholstered component loading position—is therefore simpler, quicker and requires less effort. According to one embodiment of the present invention, the construction of the seat can be made more stable with the same outlay on structural means, because the force path taken up by interconnected movable parts in the event of a crash situation of the vehicle is considerably less than that in the prior art. The seat upholstered component of the seat according to one embodiment of the invention preferably has a use side and a non-use side, the non-use side of the seat upholstered component being disposed facing the backrest component when the seat upholstered component is in its upholstered component loading position. In this embodiment, it is advantageously possible for the backrest component to be folded over substantially into the space areas in which the seat upholstered component is situated in the use position. In this embodiment, the backrest component can be folded over to produce a large loading capacity on its rear side, i.e. on its side opposite a side used for usual use of the seat, for goods to be transported in the loading space of the vehicle. According to one embodiment of the present invention, provision is further preferably made for the backrest component, in its backrest loading position, to be positioned substantially horizontal which makes it advantageously possible for the rear side of the backrest component to form a floor of the loading space to form part of a high-quality loading space.

In one embodiment of the present invention, it is possible to make provision for the seat lower component to have a first lower component and a second lower component, the first lower component being provided so that it can be rotatably moved together with the seat upholstered component and the backrest component about a third axis provided parallel to and preferably separate from the second axis. In one embodiment of the present invention, the vehicle seat is preferably further made for the backrest component to be provided so that it can be rotatably moved about the first axis from the backrest use position into a backrest folded-over position, different from the backrest loading position, and vice versa when the seat upholstered component is situated in the upholstered component use position relative to the first lower component such that the backrest folded-over position can further be arranged spontaneously and in a particularly simple manner. Provision is preferably further made for the backrest folded-over position to be passed through relative to the first lower component when the backrest component is moved from its backrest use position to its backrest loading position to differentiate the backrest folded-over position from the backrest loading position relative to the first lower component. In one embodiment of the present invention, provision is preferably further made for the backrest component situated in the backrest folded-over position relative to the second lower component and also the seat upholstered component situated in the upholstered component folded-over position relative to the second lower component, and the first lower component situated in the folded-over position relative to the second lower component, to be disposed substantially vertically (i.e. an arrangement of the backrest component in the backrest folded-over position and also of the seat upholstered component in the upholstered component folded-over position and of the first lower component in the folded-over position).

In one embodiment of the present invention, a method for folding over a seat, in the case of which, before the backrest component is adjusted to its backrest loading position, a seat upholstered component has to be moved into its upholstered component loading position, or at least substantially into its upholstered component loading position. The method according to this embodiment of the invention has the advantage that folding over the different parts of the seat from their use positions in each case into their loading positions in each case is possible in a simple manner with very little effort and also spontaneously. In one embodiment of the method, provision is preferably further made for the seat upholstered component to have a use side and a non-use side, the non-use side of the seat upholstered component facing the backrest component when the seat upholstered component is in its upholstered component loading position. This makes it advantageously possible to protect the use side of the seat upholstered component, and to protect it from the goods being transported in the loading space.

### BRIEF DESCRIPTION OF THE DRAWINGS

FIG. 1 shows a vehicle seat according to one embodiment of the invention in side view in its use position;

FIG. 2 shows the vehicle seat of FIG. 1 in its loading position;

FIG. 3 shows the vehicle seat of FIG. 1 in side view in an intermediate position towards the folded-over position;

FIG. 4 shows the vehicle seat of FIG. 1 in side view in its folded-over position;

FIG. 5 shows a seat according to one embodiment of the invention in its use position in a diagrammatically illustrated vehicle; and

FIG. 6 shows the seat of FIG. 5 in its folded-over position in a diagrammatically illustrated vehicle.

### DETAILED DESCRIPTION OF THE EXEMPLARY AND ALTERNATIVE EMBODIMENTS

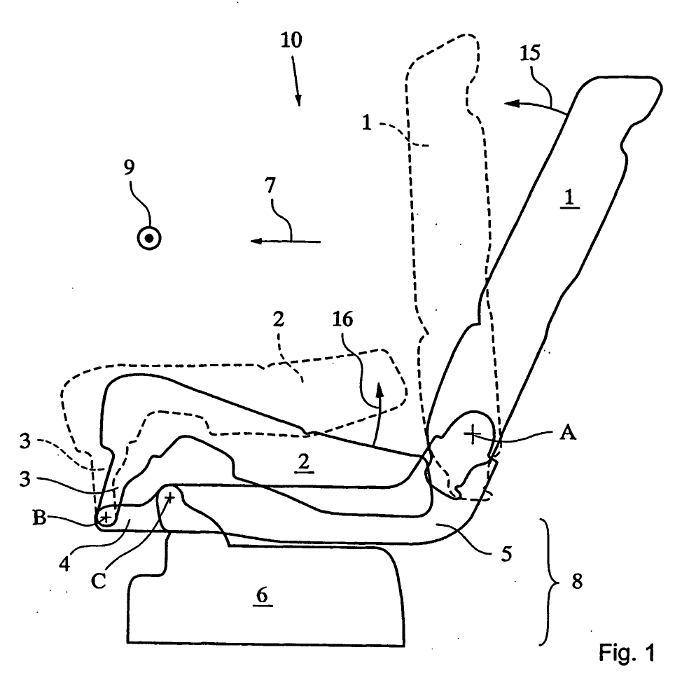

A vehicle seat 10 according to one embodiment of the invention is illustrated in side view in FIG. 1. The seat 10 has a backrest component 1 and a seat upholstered component 2. The seat 10 further has a seat lower component, which has a first lower component 5 and a second lower component 6. The seat lower component, consisting of its lower components 5, 6, is also indicated in summary below by the reference numeral 8. The first lower component 5 is designed so that it can be rotatably moved in relation to the second lower component 6 relative to a third axis C running transversally to the primary sitting direction 7. The third axis C thus runs parallel to a transversal direction provided transversally to the primary sitting direction 7, which is shown in FIG. 1 as a direction provided with reference numeral 9 pointing into the plane of the drawing. The first lower component 5 has, in addition to the third axis C, a first axis A and a second axis B, each of these axes also being provided parallel to the transversal direction 9. By means of the rotatability of the first lower component 5 relative to the second lower component 6 about the third axis C, the first axis A and the second axis B are also designed to be movable relative to the second lower component 6 depending on the adjustment of the first lower component 5. The first lower component 5 is connected to the backrest component 1 by means of the first axis A. According to one embodiment of the invention the backrest component 1 can be folded over about the first axis A relative to the first lower component 5 in accordance with a first arrow provided with the reference numeral 15 in FIG. 1. The backrest component 1 is shown a FIG. 1 in an intermediate position by means of a dashed line. The seat upholstered component 2 is designed so that it can be rotatably moved in relation to the first lower component 5 about the second axis B. The seat upholstered component 2 according to one embodiment of the invention is designed in such a way that it can be folded over along a second arrow indicated by the reference numeral 16 about the second axis B. This is shown indicatively in FIG. 1 by means of a dashed line for an intermediate position of the seat upholstered component 2. When the seat upholstered component 2 has been folded in accordance with the second arrow 16 sufficiently into a position folded away from its upholstered component use position, the backrest component 1 can be folded about the first axis A in accordance with the first arrow 15 from its backrest use position, which is shown in FIG. 1 by means of a solid line, through an intermediate position shown in FIG. 1 by means of a dashed line, into its backrest loading position (not shown in FIG. 1), in which the backrest component 1 takes up at least parts of space areas which the seat upholstered component 2 has taken up in its upholstered component use position, the upholstered component use position also being shown by a solid line in FIG. 1.

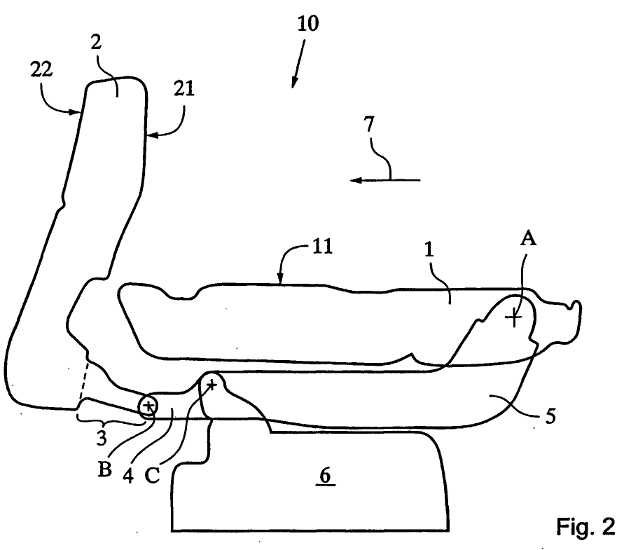

In FIG. 2 the seat 10 according to one embodiment of the invention is shown in its loading position, i.e. the seat upholstered component 2 is adjusted to its upholstered component loading position, and the backrest component 1 is adjusted to its backrest loading position. In this case, the backrest component 1 is disposed substantially horizontally and takes up space areas which the seat upholstered component 2 had taken up in its upholstered component use position shown in FIG. 1. In the upholstered component loading position (FIG. 2), the seat upholstered component 2 can be folded forward in the primary sitting direction 7 in relation to the upholstered component use position preferably by approximately 90° about the second axis B and in accordance with the second arrow 16 shown only in FIG. 1, so that the seat upholstered component 2, which has a non-use side 21 and a use side 22, faces the backrest component 1 with its non-use side 21. The approximately horizontal position of the backrest component 1 in its backrest loading position advantageously ensures that it is possible to use the rear side of the backrest component 1, indicated by reference numeral 11, as a loading space floor or as a loading space underside for the transportation of any goods desired. Owing to the fact that the non-use side 21 faces the loading area, unnecessary soiling of the use side 22 of the seat upholstered component 2, for example by means of transported goods, is effectively prevented. When the backrest component 1 and also the seat upholstered component 2 are folded over from their use position in each case into their loading position in each case, according to one embodiment of the invention, the first lower component 5 remains fully stationary relative to the second lower component 6, and only the backrest component 1 is swung or folded about the first axis A and the seat upholstered component 2 is swung or folded about the second axis B. In both cases, a fold angle or a total movement angle of approximately 90° is provided, it being possible to provide different fold angles in the case of the backrest component 1 depending on the adjustment of the backrest use position.

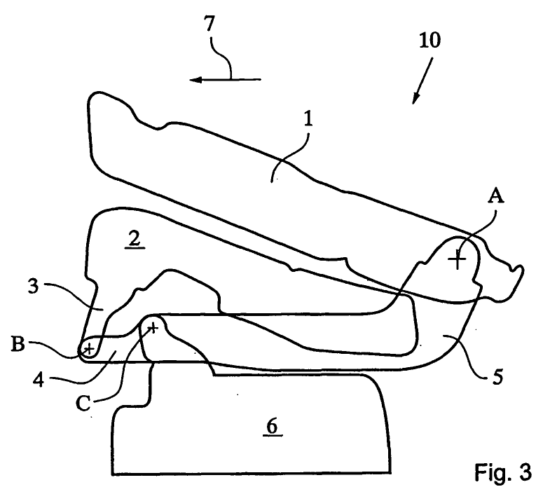

In FIG. 3 the seat 10 is shown in an intermediate position in relation to its folded-over position. In the intermediate position only the backrest component 1 is folded forward in the direction of the first arrow 15, i.e. in the primary sitting direction 7, about the first axis A, starting from its backrest use position shown in FIG. 1, a backrest folded-over position of the backrest component 1 relative to the first lower component 5 being shown in FIG. 3. In this case, according to one embodiment of the invention, starting from the backrest use position, the backrest folded-over position provides a folding movement relative to the first lower component 5 about the first axis A, this being by a smaller angle than the angle between the backrest use position and the backrest loading position. In the illustrated intermediate position of the seat 10, the first lower component 5 is still in its use position and the seat upholstered component 2 is still in its upholstered component use position.

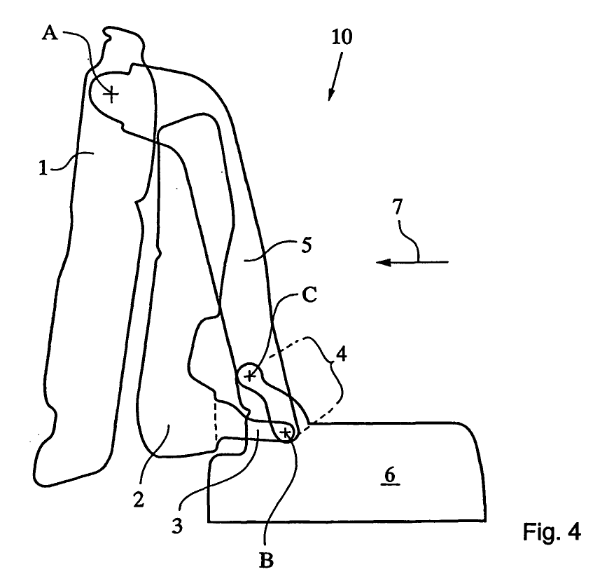

FIG. 4 shows the folded-over position of the seat 10 according to one embodiment of the invention. In this case the first lower component 5 is swung relative to the second lower component 6 about the third axis C into its folded-over position, this folding movement providing simultaneously for a change of position both of the first axis A and of the second axis B, and consequently, of the seat components of the backrest component 1 and of the seat upholstered component 2 disposed in an unchanged arrangement relative to the first lower component 5. It is therefore ensured that the seat upholstered component 2 is situated in the upholstered component folded-over position relative to the second lower component and at the same time is further situated in its upholstered component use position relative to the first lower component. The folded-over position of the seat 10 makes it possible for a user easily to reach the further seat possibilities of a vehicle disposed opposite to the primary sitting direction 7, i.e. situated behind the seat 10, by the fact that for the purpose of reaching the further seat facilities situated behind the seat 10—which seat facilities are not, however, shown in FIGS. 1 to 4—use is made of space areas which in their use position are taken up by components of the seat 10 according to one embodiment of the invention, for example by the backrest component 1 or the seat upholstered component 2.

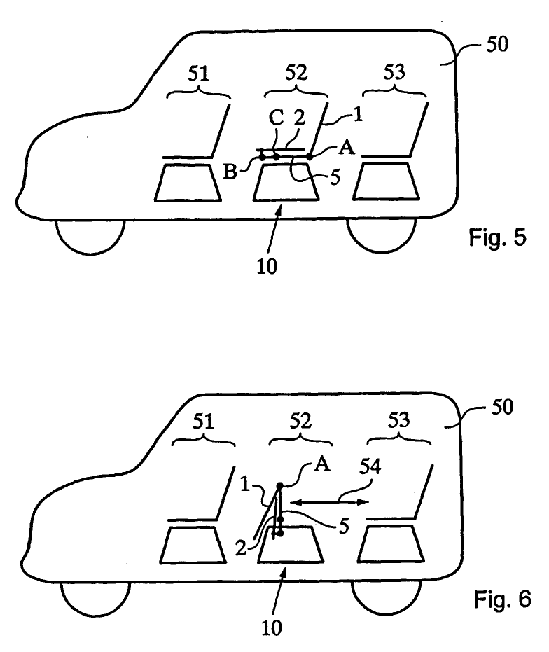

This situation is shown diagrammatically in FIGS. 5 and 6 by means of a vehicle 50, which has a first row of seats 51, a second row of seats 52 and a third row of seats 53. For example, a seat 10 according to one embodiment of the invention is provided in particular as part of a second row of seats 52.

In FIG. 5 the seat 10 is shown in its use position with the axes A, B, C and the backrest component 1, the seat upholstered component 2 and the first lower component 5.

In FIG. 6 the folded-over position of the seat 10 is shown, the folded-over position of the seat 10 ensuring that a space area indicated by the reference numeral 54 can be used to permit easy access to the third row of seats 53 for users of the vehicle 50.

The difficulty in the construction of vehicle seats permitting both a loading position for the transportation of goods and a folded-over position for easier access to a row of seats behind the seat 10 lies in making the adjustment possibilities of the individual components of the seat 10, i.e., for example, the backrest component 1, the upholstered component 2 or the first lower component 5, such that the parts of the seat 10, on the one hand, can be provided simply and economically and, on the other hand, can be connected stably to each other. By the simple provision of a folding-over possibility of the seat upholstered component 2, it is ensured that the difference between the backrest loading position and the backrest folded-over position is achieved simply by folding over the backrest component 1 about the first axis A by a greater or a lesser angle. In this way, the connection of the backrest component 1 to the seat lower component 8 can be provided in the conventional manner, i.e. by means of an adjusting mechanism which can be provided in the known manner. This means that complex solutions for connecting the backrest component 1 to the seat lower component 8, for example a two-part backrest with two adjusting elements to be locked into position, are not necessary.

On the front side of the seat 10, according to one embodiment of the invention, the seat upholstered component 2 is provided not only so that it can fold over at its front end about the second axis B, but also so that an area of the seat upholstered component 2, provided with reference numeral 3 in FIGS. 1 to 4, is disposed in the manner of a first extension 3 provided up to the second axis B, which extension works together with a second extension 4 provided on the first lower component 5 and indicated by reference numeral 4 in FIGS. 1 to 4, in such a way that, when the first lower component 5 is folded over relative to the second lower component 6 into the folded-over position of the seat 10, a lowering of the seat upholstered component 2 is achieved by the swinging of the first extension 3 and of the second extension 4 about the third axis C.

According to one embodiment of the invention, provision should be made in particular for locking mechanisms, so that movement of the first lower component 5 relative to the second lower component 6 in relation to the third axis C is prevented when the locking mechanism is locked, and such movement is possible only when the locking mechanism has been opened. Furthermore, on the connection between the first lower component 5 and the backrest component 1, about the axis A, an adjustable locking mechanism is provided in order to set a position desired by the user of the backrest component 1 in its backrest use position. Owing to the fact that the seat upholstered component 2 is connected by means of the second axis B and by means of the third axis C to the second lower component 6 connected to the vehicle 50, it is not necessary to provide two points of rotation in the backrest component 1. The seat 10 according to one embodiment of the invention therefore makes it possible to avoid two closures or two so-called recliners in the backrest component 1, both of which in an accident situation would stand in the force path and both of which would have to be locked. The second and third axes B and C about which the seat upholstered component 2 can be moved relative to the vehicle 50 according to one embodiment of the invention do not necessarily have to be additionally secured, and shorten the load path of the forces in the event of an accident.

The mechanism provided according to one embodiment of the invention for connecting the seat upholstered component 2 or the backrest component 1 to the second lower component 6, which is stationary by comparison with the vehicle 50, permits a very simple and consequently stable mechanism that can be manufactured economically, both for the loading position of the seat 10 and also for the folded-over position of the seat 10, which is also described as an easy-entry position of the seat 10.

1-12. (canceled)

13. A vehicle seat having an upholstered component and a backrest component (1), the backrest component (1) being provided so that it can be rotatably moved about a first axis (A), said first axis (A) being provided parallel to a transversal direction that runs transversally to the primary sitting direction (7), wherein the seat upholstered component (2) is provided to be rotatably moved relative to the seat lower component (8) about a second axis (B) provided parallel to the transversal direction (9) from an upholstered component use position into an upholstered component loading position and vice versa, and the backrest component (1) being provided so that it can be rotatably moved relative to the seat lower component (8) about the first axis (A) from a backrest use position into a backrest loading position and vice versa only when the seat upholstered component (2) has been moved substantially into the upholstered component loading position.

14. The vehicle seat (10) of claim 13 wherein the seat upholstered component (2) has a use side (22) and a non-use side (21), the non-use side (21) of the seat upholstered component (2) being disposed facing the backrest component (1) when the seat upholstered component (2) is in the upholstered component loading position.

15. The vehicle seat (10) of claim 14 wherein the backrest component (1) in its backrest loading position is disposed substantially horizontally.

16. The vehicle seat (10) of claim 15 wherein the seat lower component (8) has a first lower component (5) and a second lower component (6), the first lower component (5) together with the seat upholstered component (2) and the backrest component (1) being provided so that it can be rotatably moved about a third axis (C), different from the second axis (B) and provided parallel to the transversal direction (9), from a use position into a folded-over position and vice versa.

17. The vehicle seat (10) of claim 16 wherein the backrest component (1) is provided so that it can be rotatably moved about the first axis (A) from the backrest use position into a backrest folded-over position, different from the backrest loading position, parallel to the transversal direction (9) and vice versa when the seat upholstered component (2) is situated in the upholstered use position relative to the first lower component (5).

18. The vehicle seat (10) of claim 17 wherein the backrest component folded-over position relative to the first lower component (5) is passed through when the backrest component (1) is moved from the backrest component use position into the backrest component loading position.

19. The vehicle seat (10) of claim 18 wherein the backrest component (1) situated in a backrest component folded-over position relative to the second lower component (6) and also the upholstered component (2) situated in an upholstered component folded-over position relative to the second lower component (6) and the first lower component (5) situated in the folded-over position relative to the second lower component (6) are disposed so that they are substantially vertically adjustable in each case.
